(19) United States
(12) Patent Application Publication
(10) Pub. No.: US 2025/0153317 A1
(43) Pub. Date: May 15, 2025

(54) BI-DIRECTIONAL ANTI-SLIP HEX ALLEN TOOL

(71) Applicant: Robert Doroslovac, Massillon, OH (US)

(72) Inventor: Robert Doroslovac, Massillon, OH (US)

(21) Appl. No.: 18/425,372

(22) Filed: Jan. 29, 2024

Related U.S. Application Data
(60) Provisional application No. 63/548,361, filed on Nov. 13, 2023.

(51) Int. Cl. B25B 15/00

(52) U.S. Cl. CPC B25B 15/008

(57) ABSTRACT

A hex headed bit and socket for enhanced non-slip bi-directional application of torque force having a hex head with fastener engagement surfaces. The fastener engagement surfaces extend in angular longitudinal inclination. Elongated recessed areas between non-adjoining flat hexagonal free end tool portions defining alternate spaced obtuse angle pairs of parallel engagement edges correspondingly embed themselves during bi-directional rotational engagement within the so engaged fastener pulling the hex head bit into the engaged fastener imparting enhanced multiple points of tool engagement for rotational extraction.

This application claims the benefit of U.S. Provisional Application No. 63/548,361, filed Nov. 13, 2023.

### BACKGROUND OF THE INVENTION

### 1. Technical Field

This invention is directed to hex headed bits for the use with hex headed fasteners as an anti-slip multi-directional drive bit for driving and removing of hex headed fasteners. Such tool bits known and used in the art are defines as six sided flat surfaces for engagement and correspondingly configured receptacles for rotation to tighten and loosen as needed. Such fastener bolt designs may be compromised during use due to metal fatigue, rust and general abuse imparted by improper tool use thus making them difficult to engage by a typical hex headed tool.

### 2. Description of Prior Art

Prior art hex wrench and bit tool configurations can be seen in the following U.S. Pat. Nos. 4,105,056, 6,152,000, 8,302,255, 8,640,575, 10,081,094, and 10,780,556,

In U.S. Pat. No. 4,105,056, a non-slip screwdriver can be seen having a grooved foot portion from the driver blade with oppositely disposed parallel engagement grooves there across defining recessed surfaces.

U.S. Pat. No. 6,152,000 is directed to a driver bit and driver tool having a plurality of projections formed on at least one surface of the fastener engagement shank portion to enhance the tool to fastener registration engagement.

U.S. Pat. No. 8,302,255 illustrates a hexagonal wrench head with longitudinal groove adjacent the respective side surfaces edge intersections there along.

U.S. Pat. No. 8,640,575 discloses a ball end hex wrench wherein a groove is formed within the contoured multiple sides longitudinally.

U.S. Pat. No. 10,081,094 discloses a fastener extractor device having tubular sleeve with lateral bracing sidewalls with an engagement recess there within.

U.S. Pat. No. 10,780,556 is directed to a screw bit tool body having lateral edges with a concave engagement cavity in lateral bracing sidewalls.

### SUMMARY OF THE INVENTION

The present invention provides a driver bit for engaging and maintaining efficient contact within a fastener to transfer rotational force from the drive bit to the fastener while maintaining proper engagement therewith. Elongated tapered engagement surface channel cuts between alternating flat hex bit surfaces define pairs of directional engagement edges that dig into the registering fastener surfaces pulling the driver bit down within the fastener maintaining fastener engagement during rotational torque input.

### DESCRIPTION OF THE DRAWINGS

FIG. 1 is an enlarged top and front perspective view of the anti-slip hex socket bit of the invention.

FIG. 2 is an enlarged bottom plan view thereof.

FIG. 3 is an enlarged top plan view thereof.

FIG. 4 is an enlarged front elevational view thereof with portions broken away for illustration.

FIG. 5 is an enlarged side elevational view thereof.

FIG. 6 is an enlarged partial top plan view illustrating the angular orientation of the respective engagement edges of the hex socket bit of the invention.

FIG. 7 is an enlarged graphic illustration of the anti-slip hex socket engaged within a fastener for rotation.

FIG. 8 is an enlarged, top and front perspective view of an alternate anti-slip hex socket bit of the invention.

### DETAILED DESCRIPTION OF THE INVENTION

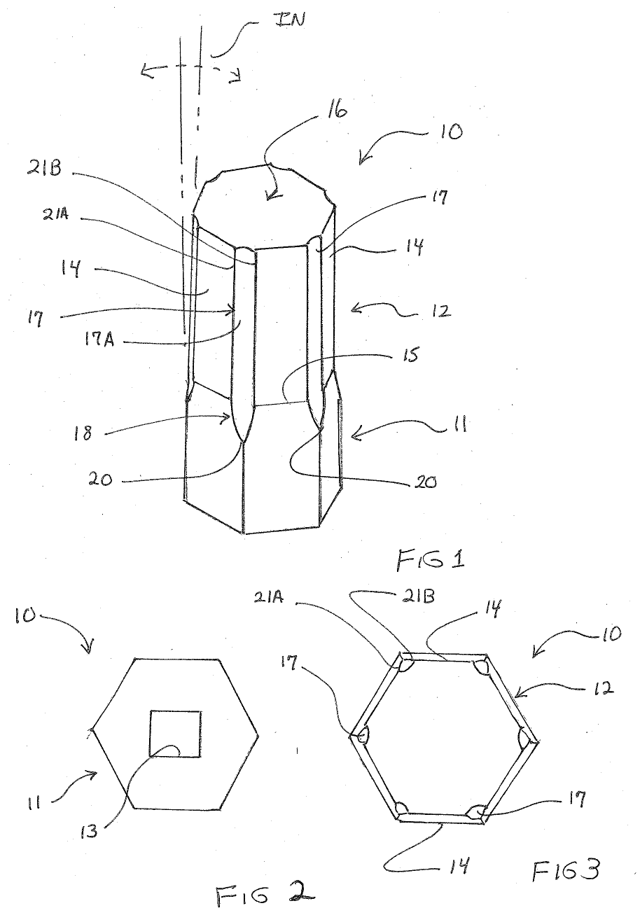

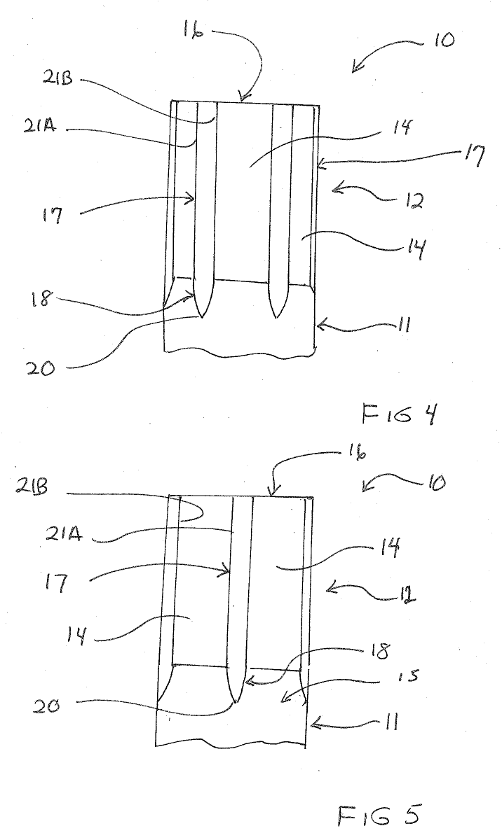

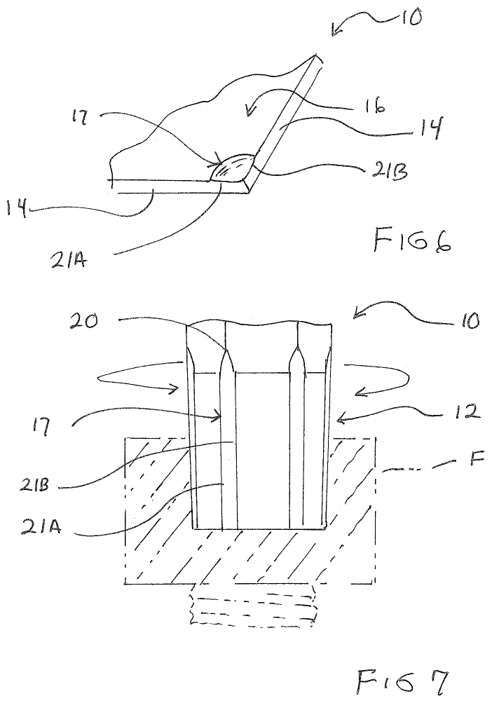

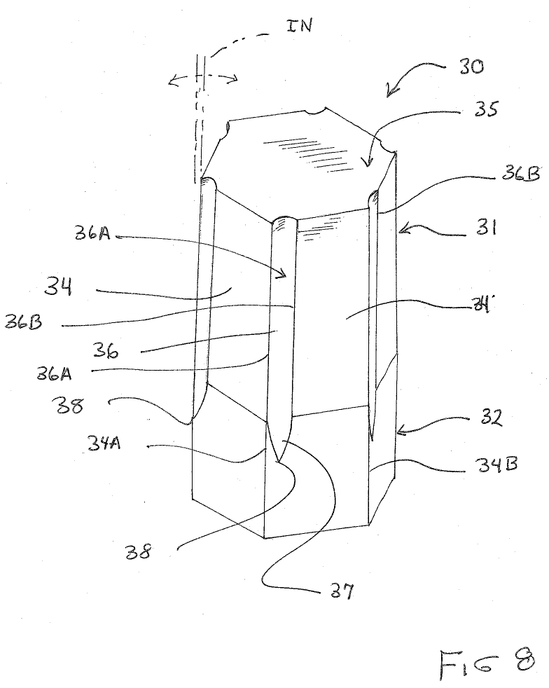

Referring to FIGS. 1-7 of the drawings, an anti-slip socket box end hex bit of the invention can be seen having a hexagonal screw bit body 11 with a hex shank fastener engagement portion 12 extending therefrom.

A driver engagement bore 13, best seen in FIG. 2 of the drawings, extends into the hexagonal screw bit body 11 and is shaped to receive a socket fitting member of a socket driver wrench, not shown, as will be evident to those skilled and well known in the art.

The hex engaged shank fastener engagement portion 12 has a plurality of elongated flat fastener engagement surfaces 14 of equal transverse and longitudinal dimension in spaced relation to one another there about so as to define a hex tool bit configuration known within the art. The fastener engagement portion 12 is therefore hexagonal with the plurality of non-adjoining flat engagement surfaces 14 spaced radially about the longitudinal axis of the fastener engagement portion 12.

Respective flat surfaces 14 are tapered from the base support 15 to a top surface 16 approximately 1% indicated in broken lines at IN in FIG. 1 of the drawings.

The hexagonal flat engagement surfaces 14 have an elongated recess area 17 adjoining adjacent respective flat surfaces 14 extending transversely within each of the adjacent flat surfaces 14 and longitudinally from the tool's top surface 16 to an end portion 18 with an angular transition surface 19 of the inclined engagement surface and the base support socket 13 receiving screw bit body 11.

Each of the elongated recess areas 17 have a transverse concave surface 17A extending from the tool's top surface 16 that tapers to the base 15 terminating at the respective end point 20.

Each of the respective elongated recesses 17 define corresponding pairs of spaced oppositely disposed parallel fastener engagement longitudinal edges 21A and 21B, best seen in FIGS. 1 and 3 of the drawings with one of said edges in each adjacent flat surface.

Each of the engagement edges 21A and 21B are defined by obtuse angle A and corresponds to their fastener engagement rotation engagement ability which is bi-directional indicated in FIG. 8 of the drawings.

Each of the obtuse angled fastener engagement edges 21A and 22B will provide frictional engagement within a fastener F during rotation of the tool 10 in either direction for wedging edge extraction as seen graphically in FIG. 8 of the drawings.

It will be evident from the above disclosure that the bi-directional extraction tool 10 provides a unique surface engagement to a fastener for extraction in which the parallel spaced fastener engagement edges 21A and 21B selectively engage and rotate the fastener F for extraction by their respective orientation, each within adjacent non-adjoining flat engagement surfaces imparted by their respective curvilinear channel width.

Referring now to FIG. 8 of the drawings, an alternate form of the invention can be seen as an anti-slip socket bit end hex bit 30 having a modified hex shank fastener engagement bit 31 with a hexagonal screw bit base 32 extending therefrom. A socket receiving opening fitting, not shown, formed in the base 32 for registration of a socket drive wrench, not shown, as is known in the art.

The hex fastener engagement shank bit 31 has a plurality of longitudinally adjoining elongated flat fastener engagement surfaces 34 there about. The respective flat fastener engagement surfaces 34 are tapered at a one-degree angle from the hexagonal screw bit base 32 to a top surface 35 from the fastener engagement portion 31. Each of the respective flat fastener engagement surfaces 34 have an elongated recess 36 therein in parallel abutting relation to one of its adjacent flat surface adjoining edges 34A and in spaced relation to the remaining oppositely disposed flat surface edge 34B in this example.

The elongated recesses 36 each have a transverse concave surface 36A extending from the top surface 35 to the screw bit base 32 with a tapered transition surface 37 terminating at the respective end points 38.

As in the primary form of the invention, each of the respective elongated recesses 36 defines pairs of parallel spaced longitudinal fastener engagement edges 36A and 36B with one of the edges 36A defined by the adjoining longitudinal flat surface edge 34A. Correspondingly, the remaining fastener engagement edges 36B are in spaced relation to the adjacent flat surface edge 34A.

It will thus be seen that a new and useful anti-slip socket wrench hex head bit configuration has been illustrated and described and it will be apparent to those skilled in the art that various changes and modifications may be made therein without departing from the spirit of the invention. Therefore, I claim:

1. A bi-directional multi-grip socket bit for hexagonal fasteners comprises,
a screw bit body having a fastener engagement free end portion and a tool engagement end portion,
a plurality of flat non-adjoining longitudinally tapered fastener engagement surfaces on said fastener engagement free end portion defining a hexagonal engagement shank with a top surface,
elongated recesses joining each of said respective flat fastener engagement surfaces defining spaced oppositely disposed parallel fastener engagement edges in each of said spaced flat fastener engagement surfaces,
said elongated recess extending from the fastener engagement free end top surface to within said tool engagement end portion,
said elongated recess surfaces are transversely concaved in fastener engagement edge to edge orientation between said respective flat fastener engagement surfaces.

2. The bi-directional multi-grip socket bit for hexagonal fasteners set forth in claim 1 wherein each of said elongated recessed have a vertical tapered curvilinear end portion between said parallel fastener engagement edges in said tool engagement end portion.

3. The bi-directional multi-grip socket bit for hexagonal fasteners set forth in claim 1 wherein said fastener engagement free end portion has right angled transition edges from said top surface to said respective annularly spaced flat tapered engagement surfaces.

4. The bi-directional multi-grip socket bit for hexagonal fasteners set forth in claim 1 wherein said fastener engagement edges are at an obtuse angle to said respective flat fastener engagement surfaces.

5. The bi-directional multi-grip socket bit for hexagonal fasteners set forth in claim 1 wherein said flat fastener engagement surfaces are of equal transverse dimension.

6. The bi-directional multi-grip socket bit for hexagonal fasteners set forth in claim 1 wherein said tool engagement portion has a plurality of flat adjoining longitudinally extending surfaces and a driver receiving bore in its free end.

7. The bi-directional multi-grip socket bit for hexagonal fasteners set forth in claim 1 wherein said elongated recess fastener engagement edges define oppositely disposed longitudinally tapered flat engagement surfaces there between.
